(19) United States
(12) Patent Application Publication
(10) Pub. No.: US 2021/0301562 A1
(43) Pub. Date: Sep. 30, 2021

(54) INTEGRATED CONTROLLER WITH SENSORS FOR LATCH HOUSING

(71) Applicant: MAGNA CLOSURES INC., Newmarket (CA)

(72) Inventor: Francesco CUMBO, Pisa (IT)

(21) Appl. No.: 17/211,250

(22) Filed: Mar. 24, 2021

Related U.S. Application Data
(60) Provisional application No. 63/000,216, filed on Mar. 26, 2020.

(51) Int. Cl. E05B 81/56; B60R 16/023; B60J 5/10; E05B 79/08; E05B 81/04; E05B 81/66; E05B 83/18

(52) U.S. Cl. CPC E05B 81/56; B60R 16/023; B60J 5/105; E05B 83/18; E05B 81/04; E05B 81/66; E05B 79/08

(57) ABSTRACT

A latch housing for a latch for mounting on a closure panel of a vehicle, the latch housing comprising: a frame having mounted thereon: a set of latch components of the latch; and an Electronic Control Unit (ECU) having at least one sensor and a processor and memory; wherein the ECU coordinates operation of the set of latch components in view of a sensor signal received from the at least one sensor.

### CROSS-REFERENCE TO RELATED APPLICATION

This application claims priority from the benefit of the filing date of U.S. Provisional Patent Application No. 63/000,216 filed on Mar. 26, 2020, entitled “INTEGRATED CONTROLLER WITH SENSORS FOR LATCH HOUSING”, the contents of which are herein incorporated by reference.

### FIELD

The present invention relates to control for closure panels of a vehicle. In particular, the present invention relates to a latch housing having integrated controller components for operating a biasing member of the closure panel.

### BACKGROUND

Vehicles are equipped with a variety of closure panel, such as a lift gate, which is driven between an open position (position 2) and a closed position (position 1) using an electric drive system. Vehicle closure panels can employ struts to assist the vehicle operator to open the closure panel, close the closure panel, and help maintain the closure panel in the open position or in an intermediate hold position (third position hold). Typically, the struts can be biased and can also be automatically controlled via an electric motor of the electric drive system. These struts are important in terms of both convenience and safety, because without them, vehicle operators can risk injury when entering or exiting the vehicle via the closure panel, e.g. when loading or unloading the vehicle.

Due to the shape of a lift gate latch, positioning sensors to appropriately monitor the mechanics of the latch can be an issue. Further, coordinating control between the latch and other mechanized biasing elements of the control panel can be problematic, when control units are utilized which are remote from the latch. These remote control units can have issues with respect to proper sensor positioning and functioning in terms of latch and biasing member control.

Therefore, it is desirable to employ sensors with vehicle closure panels for ease of operation. However, available space is typically limited in the vicinity of the strut mounting and latch mounting on the vehicle frame. Further, remote placement of the sensors can also be problematic due to signal noise considerations for position/obstacle sensing during operation of motors included in the electric drive systems of the strut and/or latch.

### SUMMARY

It is an object of the present invention to provide a latch with an integrated controller to obviate and/or mitigate at least one of the above-presented disadvantages.

With respect to at least one of the above presented disadvantages, it is an advantage of the present invention to position electronic control circuitry positioned sensors to obviate or mitigate at least one of the above-presented disadvantages.

A first aspect provided is a latch housing for a latch for mounting on a closure panel of a vehicle, the latch housing comprising: a frame having mounted thereon: a set of latch components of the latch; and a latch control module including an Electronic Control Unit (ECU) having at least one sensor and a processor and memory; wherein the ECU coordinates operation of the set of latch components in view of a sensor signal received from the at least one sensor.

A further aspect provided is a method of providing a latch mounted in a latch housing, the latch housing for mounting on a closure panel of a vehicle, the method comprising: positioning on a frame of the latch housing: a set of latch components of the latch; and a latch control module including an Electronic Control Unit (ECU) having at least one sensor and a processor and memory; and coordinating operation of the set of latch components by the ECU in view of a sensor signal received from the at least one sensor.

A further aspect is the ECU coordinating operation of an electronic motor assembly of a biasing member in response to receiving the sensor signal from the at least one sensor.

### BRIEF DESCRIPTION OF THE DRAWINGS

Reference is made, by way of example only, to the attached figures, wherein:

FIG. 1 is a side view of a vehicle with a closure panel assembly;

FIG. 2 is a further embodiment of the vehicle of FIG. 1;

FIG. 2A is an illustrative system block diagram;

FIG. 3 shows an example configurations of a frame of the latch mechanism of FIGS. 1 and 2;

FIG. 4 shows the latch mechanism of FIG. 3 in a primary latch position;

FIG. 5 shows an alternative view of the latch mechanism of FIG. 3 in a primary latch position;

FIG. 6 shows example ECU configurations of a latch control module of FIG. 1;

FIG. 7 shows a further embodiment of the latch control module of FIG. 1 in association with a latch;

FIGS. 8a,8b show further embodiments of the latch control module of FIG. 1;

FIG. 9 shows a further embodiment of the latch control module of FIG. 1;

FIGS. 10a,10b show example applications of the latch control module of FIG. 1; and

FIGS. 11, 12, 13 and 14 show alternative embodiments of operation and implementation of the latch housing of FIG. 1 incorporating the latch control module.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

In the following description, details are set forth to provide an understanding of the disclosure. In some instances, certain software, circuits, structures, techniques and methods have not been described or shown in detail in order not to obscure the disclosure. The term “control unit” is used herein to refer to any machine for processing data, including the data processing systems, computer systems, modules, electronic control units (“ECUs”), controllers, microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g. control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

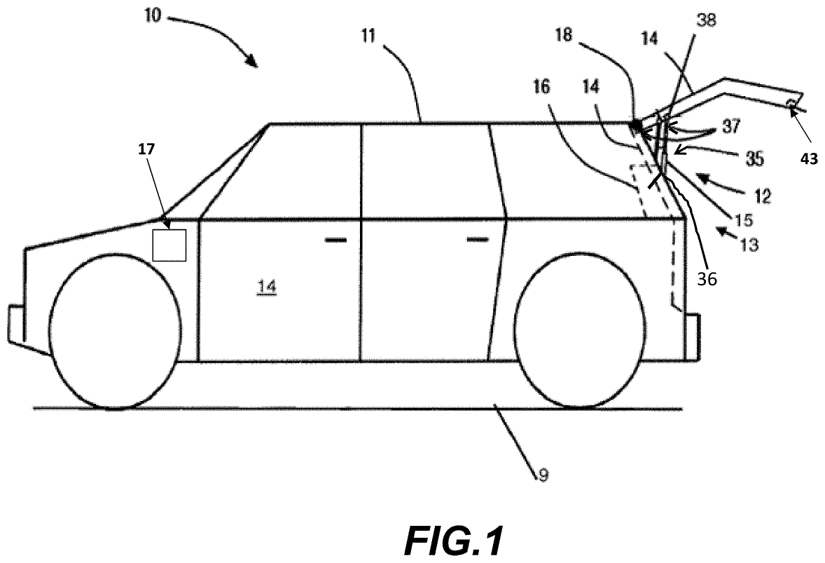

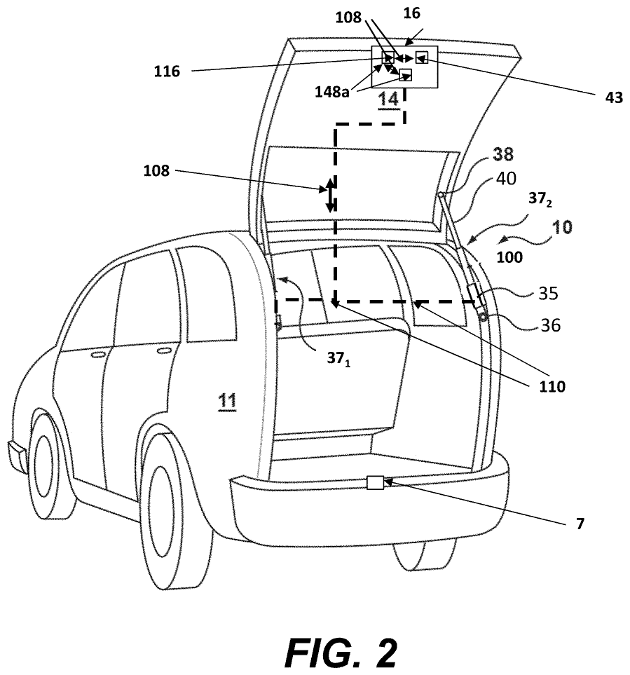

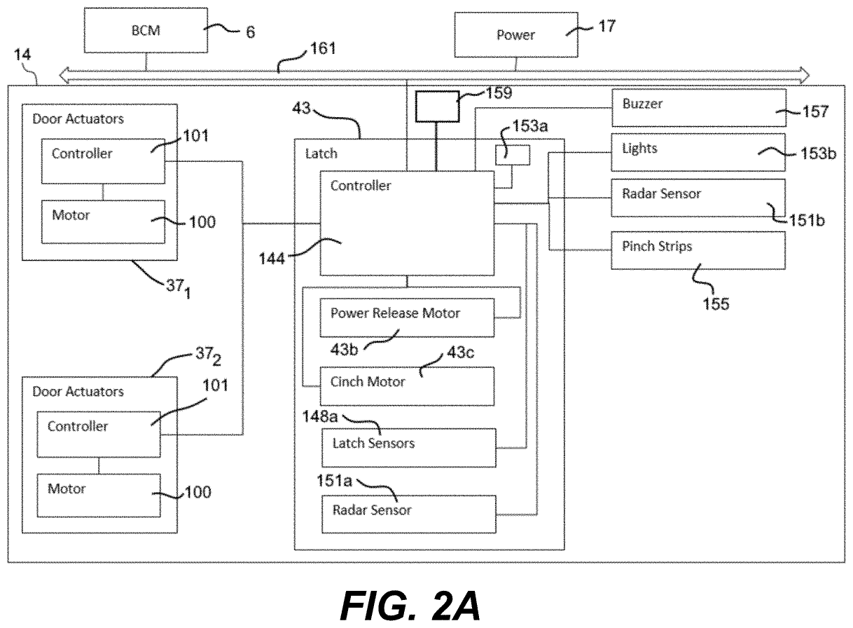

Referring to FIGS. 1 and 2, an electronic motor assembly 15 is integrated within a housing 35 of an electromechanical biasing member 37 such as a spring loaded strut, for example provided as a component of a closure panel assembly 12, as further described below. The housing 35 also contains an extension member 40 used to extend from, or retract within, the housing 35 to effect the resulting location of the closure panel 14 with respect to a body 11 of the vehicle 10. For example, an extended extension member 40 results in positioning the closure panel 14 in an open state, while a retracted extension member 40 results in positioning the closure panel 14 in a closed state with respect to opening 13. It is recognized that the electromechanical biasing member 37, incorporating the electronic motor assembly 15, having one or more motors 100, can be implemented as a strut. The strut can be of a biasing type (e.g. spring and/or gas charge supplying the bias). As such, via the incorporation of the electronic motor assembly 15, the strut is an electromechanical system, driven by the electronic motor assembly 15 with optionally spring and/or gas charge supplying the bias. The closure panel 14, e.g. lift gate, is connected to the body 11 of the vehicle at one end by pivot axis 18 (e.g. hinge) and at another end by a latch 43 (e.g. elatch 43) having a latch housing 16 mounted on the closure panel 14.

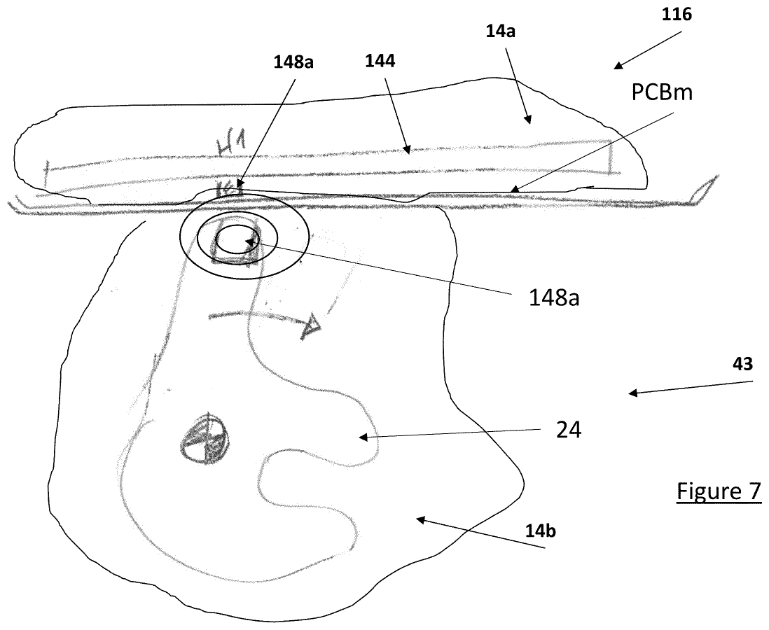

Referring again to FIGS. 1 and 2, shown is the vehicle 10 with the vehicle body 11 having one or more closure panels 14. One example configuration of the closure panel 14 is a closure panel assembly 12 including electronic motor assembly 15 (e.g. incorporated in a electromechanical biasing member 37 embodied as a strut by example) and a closure panel control system, such as a latch control module 116 (see FIGS. 1, 7, e.g. embodied with the elatch 43) mounted in the latch housing 16. The latch housing 16 is mounted to the body 11 of the closure panel 14, as further described below (i.e. spaced apart and external/remote from the electronic motor assembly 15). The latch control module 116 is coupled to the electronic motor assembly 15 via a communication path illustratively established over communication connection(s) 110 (e.g. wired and/or wireless communication—see FIG. 2). It is recognized that the latch control module 116 is in communication with the electronic motor assembly 15 via the communication connections 110. Similarly, the latch control module 116 is in communication with the elatch 43 via the communication connections 110.

For example, the communication connection(s) 110 can be used to supply operating power to the electronic motor assembly 15, which may be illustratively provided from a main vehicle power source 17, such as the vehicle main battery, or other power source and/or backup energy source. For example, the communication connection(s) 110 can be used to facilitate data and/or command signal communication between a signal source (e.g. located remote to the housing 35 such as the latch control module 116) and the electronic motor assembly 15. For example, the communication connection(s) 110 can be used to supply both operating power to the electronic motor assembly 15 as well as facilitating data and/or command signal communication between the signal source (e.g. latch control module 116 located remote to the housing 35) and the electronic motor assembly 15. For example, the communication connector(s) 110 can be configured to communicate signals associated with Local Interconnect Network protocol signals, power supply signals, and electrical ground signals. It is recognized that a battery or other type of backup power source (not shown) can be housed in the housing 35 in applications where the housing 35 footprint (e.g. dead length) is not a limiting constraint, and thus used to supply power to the electronic motor assembly 15, such that the communication connection(s) 110 can be used to charge the battery periodically. In one embodiment, the communication connection(s) 110 can be used to supply both power and data/command signaling. In a further embodiment, the communication connection(s) 110 can be used to supply power while data/command signaling is provided via wireless communication.

For example, the communication connection(s) 110 can be used to supply operating power to the elatch 43, which may be illustratively provided from a main vehicle power source 17, such as the vehicle main battery, or other power source and/or backup energy source. For example, the communication connection(s) 110 can be used to facilitate data and/or command signal communication between a signal source (e.g. located local to the latch housing 16 such as the latch control module 116) and the elatch 43. For example, the communication connection(s) 110 can be used to supply both operating power to the elatch 43 as well as facilitating data and/or command signal communication between the signal source (e.g. latch control module 116 located local to the latch housing 16) and the elatch 43. For example, the communication connector(s) 110 can be configured to communicate signals associated with Local Interconnect Network protocol signals, power supply signals, and electrical ground signals. It is recognized that a battery or other type of backup power source (not shown) can be housed in the latch housing 16 in applications where the latch housing 16 footprint (e.g. dead length) is not a limiting constraint, and thus used to supply power to the elatch 43, such that the communication connection(s) 110 can be used to charge the battery periodically. In one embodiment, the communication connection(s) 110 can be used to supply both power and data/command signaling. In a further embodiment, the communication connection(s) 110 can be used to supply power while data/command signaling is provided via wireless communication.

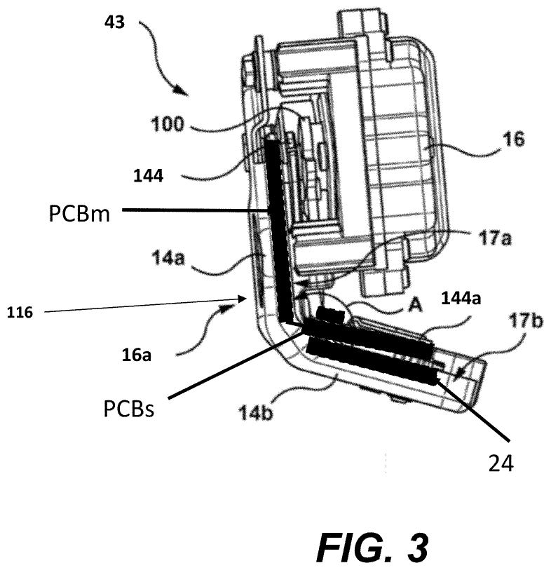

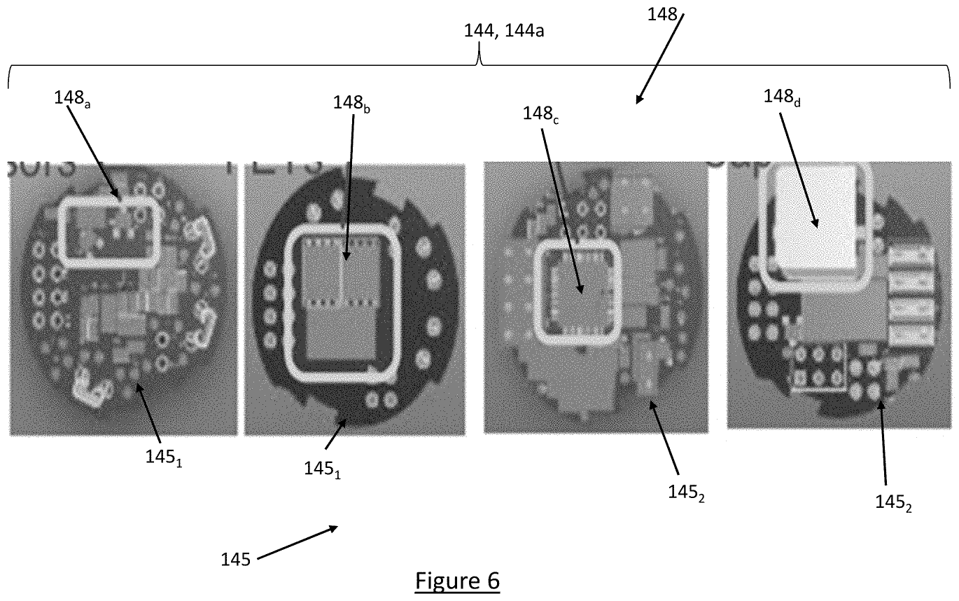

As such, it recognized that that latch control module 116, see FIG. 3, can be used to control the latch 43 (e.g. coordinate operation of a ratchet 24 and other latch components 23) as well as communicate with one or more of a plurality of sensors 148ₐ (mounted on a main PCBm and slave PCBs—see FIGS. 3, 6) positioned on or within the latch housing 16, preferably on an ECU 144 and/or an auxiliary ECU 144a of the latch control module 116. In this manner, the latch control module 116 can also operate to receive signals from the plurality of sensors 148ₐ and operate accordingly thereon, as further described below. For example, as further described below, one or more of the sensors 148ₐ (e.g. Radar Tx, Rx) can be positioned in the latch control module 116 (e.g. on the ECU 144 of the latch control module 116). As described below, the latch control module 116 can be contained wholly within the confines of the latch housing 16, and can coordinate power/data/command signals via the communication connections 110 with the latch 43 and/or the electronic motor assembly 15. In particular, both electronic control circuitry (e.g. ECU 144) for the latch 43, and the latch 43 itself, can be mounted within the interior of the latch housing 16 without increasing the dimensions of the latch housing 16, as desired.

For vehicles 10, the closure panel 14 can be referred to as a partition or door, typically hinged, but sometimes attached by other mechanisms such as tracks, in front of the opening 13 which is used for entering and exiting the vehicle 10 interior by people and/or cargo. It is also recognized that the closure panel 14 can be used as an access panel for vehicle 10 systems such as engine compartments and also for traditional trunk compartments of automotive type vehicles 10. The closure panel 14 can be opened to provide access to the opening 13, or closed to secure or otherwise restrict access to the opening 13. It is also recognized that there can be one or more intermediate hold positions of the closure panel 14 between a fully opened position and fully closed position, which can be facilitated by operation of the electronic motor assembly 15. For example, the electronic motor assembly 15 can assist in movement of the closure panel 14 to/away from one or more intermediate hold position(s), also known as Third Position Hold(s) (TPHs) or Stop-N-Hold(s), once positioned therein. The electronic motor assembly 15 can assist with the opening and closing of the closure panel 14 in a desired manner, such as based upon a desired speed of movement, the desired third position holds, the desired anti-pinch functionality whereby the movement of the closure panel 14 is stopped from closing to avoid objects, obstacles, and limb members (e.g. fingers) from being pinched between the closure panel 14 and the vehicle body 11, and the desired obstacle detection functionality whereby the closure panel 14 is stopped to avoid obstacles and objects from being impacted by the moving closure panel 14. In a preferred embodiment, the closure panel 14 can be a lift gate as shown by example in FIGS. 1 and 2.

As such, in terms of vehicles 10, the closure panel 14 can be the lift gate as shown in FIG. 1, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to laterally swing (or slide) away from (or towards) the opening 13 in the vehicle body 11 of the vehicle 10. Also contemplated are sliding door embodiments of the closure panel 14 and canopy door embodiments of the closure panel 14, such that sliding doors can be a type of door that opens by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the vehicle body 11 of the vehicle 10 at the front, side or back of the door, as the application permits.

Referring again to FIG. 1, in the context of a vehicle application of a closure panel 14 by example only, the closure panel 14 is movable between a closed position (shown in dashed outline) and an open position (shown in solid outline). In the embodiment shown, the closure panel 14 pivots between the open position and the closed position about a pivot axis 18, which is preferably configured as horizontal or otherwise parallel to a support surface 9 of the vehicle 10. In other embodiments, the pivot axis 18 can have some other orientation such as vertical or otherwise extending at an angle outwards with respect to the support surface 9 of the vehicle 10. In still other embodiments, the closure panel 14 can move in a manner other than pivoting, for example, the closure panel 14 can translate along a predefined track or can undergo a combination of translation and rotation between the opened and closed positions.

Referring again to FIG. 1, exemplary embodiments of the electronic motor assembly 15 (provided below) for the closure panel assembly 12 can be used as the means of open and close assistance for the closure panels 14 themselves (see FIG. 2), or can be used in combination (e.g. in tandem or otherwise integrated) with one or more other closure panel biasing members 37 (e.g. spring loaded hinges, struts such as gas struts or spring loaded struts, etc.) that provide a primary connection of the closure panel 14 to the vehicle body 11 at a pivot connection 36 (see FIG. 1). In general configuration of the closure panel assembly 12, the electronic motor assembly 15 can be incorporated within a housing 35 (also referred to as lever mechanism or arm or element) used to connect the closure panel 14 as a secondary connection of the closure panel 14 to the vehicle body 11, such that the extension member 40 and the housing 35 (of the closure panel electromechanical biasing member 37) can be pivotally attached to the closure panel 14 at spaced apart pivot connections 36, 38 as shown. In this manner, the end of the housing 35 pivotally connects to the closure panel 14 at pivot connection 38. It is recognized that the housing 35 itself can be configured to contain a non-biasing element (e.g. a solid extension rod 40) or can be configured to contain a biasing element (e.g. a gas or spring assisted extension strut containing biasing element(s)) along with the extension member 40, as desired.

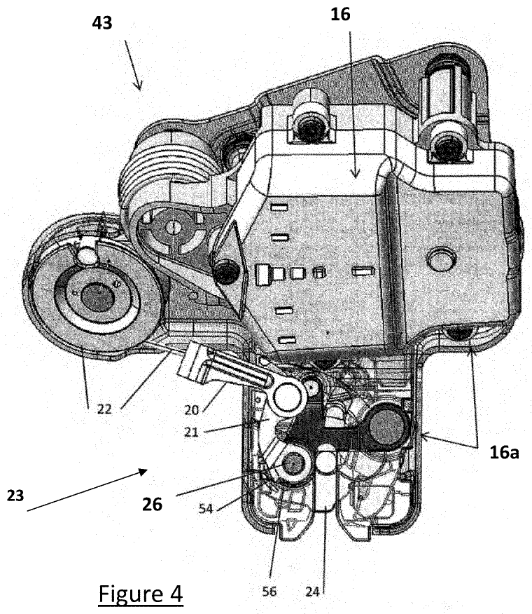

Referring again to FIG. 1, one or more optional closure panel biasing members 37 can be provided which urge the closure panel 14 towards the open position throughout at least some portion of the path between the opened position and the closed position and which assist in holding the closure panel 14 in the opened position. The closure panel biasing members 37 can be, for example, gas extension struts which are pivotally connected at their proximal end to the closure panel 14 and at their distal end to the vehicle body 11. In the embodiment shown in FIG. 2, there are two biasing members 37 (one on the left side, i.e. closure panel biasing member 37₁) of the vehicle 10 and one on the right side, i.e. closure panel biasing member 37₂) of the vehicle 10, such that the closure panel assembly 12 includes the closure panel 14 and a pair of biasing members 37_{1,2} (also referred to generically as biasing members 37) acting to control the movement of the closure panel 14. It is recognized that one or both of the biasing members 37 can incorporate the electronic motor assembly 15 within the housing 35, i.e. thus configured as the electromechanical biasing member 37. In one example, see FIG. 4, the electronic motor assembly 15 is incorporated within the electromechanical biasing member 37 in order to provide a motorized version, such that the extension member 40 is actively driven by the electronic motor assembly 15. The second biasing member 37₂ is positioned at another side of the closure panel 14, as a same or differently configured biasing member 37₁. In the embodiment as a differently configured biasing member 37₂, the housing 35 may not contain (any electronic motor assembly 15 and as such this biasing member 37₂ would be passively operated by motion of the closure panel 14. In either configuration, it is recognized that during operation of the biasing member(s) 37, the extension member 40 is either extended from, or retracted into, the housing 35.

Referring to FIGS. 3, 4, 5, the latch 43 includes a number of latch elements 23 (e.g. ratchet 24, cinch linkage 22, cinch lever 21 and pawl 25) that are configured to cooperate with a mating latch component 7 (e.g. striker) in order to retain the mating latch component 7 within slots 3,103 when the closure panel 14 (see FIG. 1) is in the closed position (e.g. locked), or otherwise to drive the mating latch component 7 out of the slots 3,103 when the closure panel 14 is in the open position. The fish mouth or slot 3 of the ratchet 24 is sized for receiving the mating latch component 7 therein, similar to the slot 103 of the latch housing 16, in other words the slots 3,103 of the latch 43 are configured for receiving a keeper (e.g. striker) of the mating latch component 7.

The latch elements 23 of the ratchet 24 and pawl 25 are pivotally secured to a frame plate 16a (of the latch housing 16) via respective shafts 26. Note that in FIG. 4 the latch 43 with associated ratchet 24 are shown in the fully or primary closed position (e.g. facilitating the retention of the mating latch component 7 within the slot 3). It is recognized that the latch 43 can also be of a non-cinch version, meaning that the cinch lever 21 may be absent and instead a member 20 (e.g. release member) is coupled to the pawl 25, as desired. In the non-cinch latch version, the latch 43 does not have the ability to cinch the striker 7 into the slot 3 of the ratchet 24 during closure of the latch 43, rather the latch 43 operates (under influence of an actuation mechanism 43a—for example consisting of associated levers, motor(s) 100 and/or gears) the ratchet 24 and pawl 25 to effect release or detainment of the matching latch component 7 in the slot 3. Actuation mechanism 43a may for example have a single motor for effecting a power release operation in a non-cinch version of the latch 43, or may have a single for effecting both cinch and power release function in a cinch version of the latch 43. Or may have a multiple motors each for effecting either a cinch or a power release function in a cinch version of the latch 43, as Illustratively FIG. 2A shows the latch 43 configured with a power release motor 43b and a cinch motor 43c each controlled by the ECU 144.

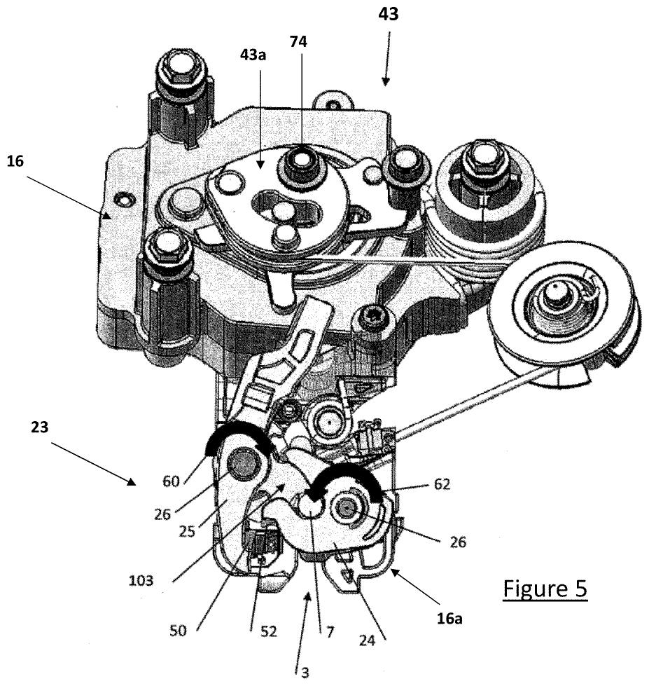

Referring to FIG. 5, the latch components 23 can include a number of biasing elements (for example springs), such as ratchet biasing element that biases rotation 62 of the ratchet 24 about the shaft 26 to drive the mating latch component 7 out of the slot 3 (thus moving the closure panel 14 towards the open position), pawl biasing element that biases rotation 60 of the pawl 25 about the shaft 26 to retain the ratchet 24 in the closed position (i.e. restrict rotation 62 of the ratchet 24 about the shaft 28 under the influence of the ratchet biasing element), cinch biasing element that can bias rotation of the cinch lever 21 towards an un-cinched position for the ratchet 24 about shaft 26 and linkage biasing element that biases return of the cinch linkage 22 towards an un-cinched position of the ratchet 24.

In terms of cooperation of the various latch components 23 with one another, a plurality of detents (also referred to as shoulder stops) can be employed to retain the latch components 23 in position until acted upon. For example, as can be seen in FIG. 3, the ratchet 25 has a detent 50 (or shoulder stop) that mates with detent 52 (or shoulder stop) of the ratchet 24, thus retaining the ratchet 24 in the closed position. As shown in FIG. 5, rotational movement 60 of the pawl 25 about shaft 26 removes detent 50 from contact with detent 52, against the bias of pawl biasing element, thus allowing for rotational movement 62 of the ratchet 24 about the shaft 26 (e.g. under the influence of the ratchet biasing element). Rotational movement 62 results in movement of the mating latch component 7 towards the open end of the slot 3 and therefore out of the slot 103. Referring to FIG. 4, shown is detent 54 (or shoulder stop) positioned on the cinch arm lever 21 in contact with detent 56 (or shoulder stop) positioned on the ratchet 24. As such, contact between the detents 54,56 provides for corotation of the cinch lever 21 and the ratchet 24 about the shaft 26, in relation to the cinching operation of the latch 43.

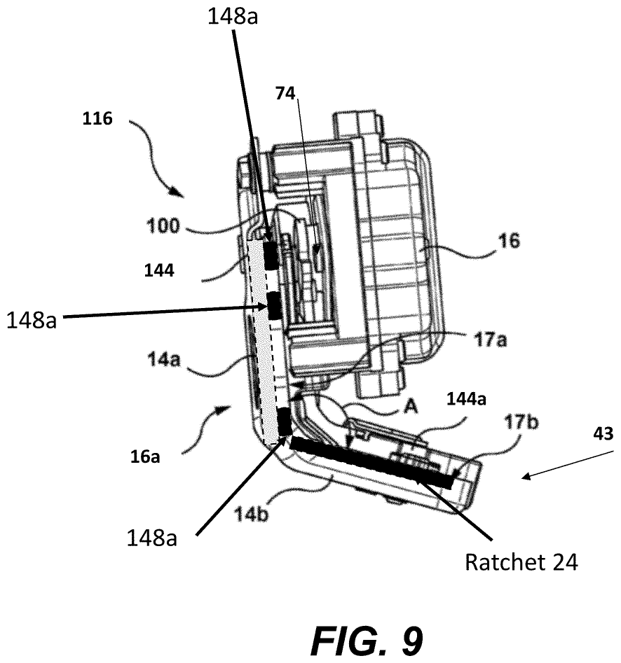

Referring to FIGS. 3, 4 and 5, the latch housing 16 can have the frame 16a configured for mounting to either the body 11 or the closure panel 14 of the vehicle 10, the frame 16a having a first frame portion 14a with a first mounting surface 17a and a second frame portion 14b with a second mounting surface 17b (see FIG. 9), the second frame portion 14b extending from the first frame portion 14a such that the first frame portion 14a and the second frame portion 14b are on different planes (e.g. the sensor 148a on the first frame portion 14a is on a different plane to that of the second sensor 148a on the second frame portion 14b). For example, the sensor 148a on the second frame portion 14b could be used to detect the position of the ratchet 24. The actuation mechanism 43a is mounted on the first mounting surface 17a and it is recognized that the (motorized) actuation system 43a can have the one or more motors 100 coupled to an output shaft 74 having a longitudinal axis mechanically coupled to the other latch components 23. The latch components 23 can be mounted on the second mounting surface 17b, including the cinch lever 21 and the ratchet 24 for operating the latch 43 from a partially closed latch position to a fully closed and cinched position, as an example of cinching operation.

Referring to FIG. 7, the sensor 148a (e.g. hall sensor) is on the main PCBm, which is on a different plane to that of the ratchet 24. The sensor 148a on the ratchet 24 could be a magnet compatible with the hall sensor 148a on the main PCBm.

In any event, in view of the above, it is recognized that the ECU 144 (including the main PCBm) can be mounted on the first frame portion 14a and at least some of the latch components 23 (e.g. ratchet 24 and pawl 25) are mounted on the second frame portion 14b.

For example, one configuration of the latch housing 16 is where the second frame portion 14b extends from the first frame portion 14a at an acute angle A (see FIGS. 3, 4, 5, 8a, 8b, 9) as measured between the mounting surfaces 17a,17b, such that the frame 16a is an angled frame 16a and the actuation mechanism 43a is mounted on the first frame portion 14a. This configuration of the angled frame 16a provides for advantages of non-parallel and/or non-coplanar orientations of different closure panel 14 constructions. In terms of allowance for multiple latch and actuator planes, it is recognized that the first frame portion 14a can define the first mounting surface 17a as an actuation mechanism 43a plane and the second frame portion 14b can define the second mounting surface 17b as a latch 43 plane (for the latch components 23 cooperating with the mating latch component 7), such that the motorized actuation mechanism 43a associated with the actuation mechanism 43a plane 17a is compatible with different versions of the angled frame 16a having a different angles A, as dictated by packaging considerations of differently configured closure panels 14. As discussed, it is also recognized that the sensors 148ₐ can be mounted on the ECU 144, which is itself mounted on the first frame portion 14a.

Further, each of the different versions of the angled frame 16a can have a corresponding respective latch 43 configuration such that each of the respective latch 43 configurations can include at least one of the plurality of latch components 23 having an angled body compatible with the respective different angle A for the angled frame 14a version. For example, as shown in FIG. 5, the pawl 25 can have an angled body compatible with the angle A as shown. It is recognized that the angled frame 16a can be manufactured such that the first frame portion 14a is materially integral with the second frame portion 14b.

Referring again to FIG. 3, as such, the first frame portion 14a can have the main ECU 144 of the latch control mechanism 116 and the second frame portion 14b can optionally have an auxiliary (e.g. slave) ECU 144a, as desired. Further, the auxiliary ECU 144a can have one or more sensors 148ₐ, such that the sensors 148ₐ are in communication with processing electronic components of the main ECU 144 (containing the main PCBm).

Referring to FIG. 6, the ECU 144 (e.g. as an electronic control unit) can be configured to function as a master controller, or as a slave controller to a master controller located externally to the latch housing 16. In any event, it is recognized that the ECU 144 (and optional slave ECU 144a) can be used to control the actuation mechanism 43a of the latch 43 as well as to control the electronic motor assembly 15 of the biasing element(s) 37 (see FIG. 2). The ECU 144 can be provided as one or more controller boards, also referred to as Printed Circuit Boards 145_{1,2,3,4} (e.g. PCBm,s portions), containing a number of electronic components 148_{a,b,c,d} mounted thereto using techniques such as soldering for example. The PCB 145, as generally known in the art as an example of the main PCBm and/or slave PCBs, provides a substrate for mechanically supporting the components 148 thereto as well as providing electrical connections for the electronic components 148 with one another using conductive traces, pads and other features etched from one or more sheet layers of copper laminated onto and/or between sheet layers of a non-conductive substrate. Components 148 are generally soldered onto the PCB 145 to both electrically connect and mechanically fasten them to the PCB 145.

As shown, the ECU 144 can be implemented as the master controller, as the slave controller, or as a combination thereof. Illustratively as shown in FIG. 6, the PCB 145 of the ECU 144, 144a can be a double sided PCB 145. Shown are example electronic components 148 on the ECU(s) 144,144a for example as mounted to the boards surfaces of the PCBs 145, located within the latch housing 16, as powered/communicated with via communication connection(s) 110 (e.g. electrical cabling). The various electronic components 148 can be mounted through press-fitting or soldering for example onto one board surface or onto both the opposite board surfaces), for example sensors 148ₐ for detecting the rotational position/displacement of motors of the actuation mechanism 43a of the latch 43 as well as the electronic motor assembly 15 of the biasing member(s) 37, further the sensors 148ₐ could also be used to detect/indicate speed, position, torque output, etc. of various latch components 23 as well as various components of the electronic motor assembly 15; motor control field-effect transistors (FETSs) 148_{b} for directing operation of the motors rotational speed/position/direction e.g. acting as a load switch to connect or disconnect a source of electrical energy (voltage and/or current) to be supplied by the ECU 144,144a to the motor 100; a microprocessor or processor and associated memory 148_{c} illustratively shown as System in Package (SIP) micro-controller logic having number of integrated circuits enclosed in a single module or package such as a microchip mounted to the PCB 145; as well as electrolytic capacitors 148_{d}, resistors and other passive and/or active components for power and signaling conditioning requirements of the motors, electronic sensors 148ₐ, and processor/memory 148_{c} and other components 148 are provided. It is advantageous to have the sensors 148ₐ mounted on the PCB(s) 145 of the ECU 144,144a, located within the latch housing 16.

It is recognized that one embodiment shown in FIGS. 2 and 6 can have the ECU 144,144a configured as the master controller configured to issue one or more actuations signals 108 to actuate the motor(s) 100 (of the actuation mechanism 43a and/or the electronic motor assembly 15) based on the command control signals 108 received via the communication connection(s) 110 in order to move the closure panel 14 between the open position and the closed position, including coordination with operation of the latch components 23 (see FIG. 4).

As such, the communication connection(s) 110 would be used to supply a generic indication of an open or close signal 108, as an example, issued from the ECU 144, (for example in conjunction with a BCM and/or a key fob over wireless link, an exterior closure panel handle, an interior closure panel handle—not shown) for receipt by the ECU 144,144a acting as the master controller. BCM 6 is shown illustratively as being in communication with the ECU 144 over a communication network or bus 161, which may be one or more electrical signal wiring, or over a wireless communication network. Bus 161 may also be configured to supply power to the latch 43 from the power supply 17, such as by a dedicated power line(s) for example. The command 108, such as an open or close command, would not be directly transmitted by the ECU 144,144a to the motor(s) 100, rather the ECU 144,144a would be responsible for processing the open/close command 108 and then generating additional actuation signals for direct consumption by the motor(s) 100 (see FIGS. 2 and 3). In terms of master controller functionality, the ECU 144,144a operating as the master controller would be responsible for implementing control logic stored in the physical memory 148_{c} for execution by a data processor, such as processor 148_{c}, to generate the actuation signals (e.g. in the form of a pulse width modulated voltage for turning on and turning off motor(s) 100 and controlling their direction and speed of output rotation.

The ECU 144,144a can be electrically coupled a motor driver component 148 including field-effect transistors (FETSs) 148_{b} which are appropriately controlled (switched on/off) by the ECU 144,144a to generate the actuation signals. Circumstances surrounding the control of the motor(s) could include receiving sensor signals (via electronic components 148ₐ as sensors—e.g. position sensors, direction sensors, obstacle sensors, digital and analog hall sensor, etc.) by the master controller as the ECU 144,144a, processing those sensor signals, and adjusting operation of the motor(s) 100 accordingly via new and/or modified actuation signals (e.g. adjust the period of PWM based actuation signals in the configuration where the motor 100 is responsive to supplied PWM signals). In this example, sensor signals of sensors 148ₐ and the actuation signals are generated and processed internally in the latch housing 16 by the ECU 144,144a, in conjunction with the motor 100 of the latch 43 also mounted within the latch housing 16. As such, signals 108 could represent generic open/close signals, or other commands, coming from the handle(s), or other control system etc., while the actual actuation signals received by and consumed (i.e. processed) by the motor 100 would be generated by the ECU 144,144a. It is also recognized that sensor signals of sensors 148ₐ and the actuation signals are generated and processed internally in the latch housing 16 by the ECU 144,144a, in conjunction with the motor 100 mounted within the housing 35 (i.e. external and remote to the latch housing 16). As such, these signals 108 could represent generic open/close signals, or other commands, coming from the handle(s), or other control system etc., while the actual actuation signals received by and consumed (i.e. processed) by the motor 100 would be generated by the ECU 144,144a.

Referring again to FIG. 6, the integrated ECU 144,144a of the latch housing 16 can include the processor (e.g. microprocessor or processor 148c) and a set of instructions stored in the physical memory 148c for execution by the processor 148c to determine the actuation signals (for example, actuation signals in the form of a pulse width modulated voltage for turning on and turning off motor(s) 100 and controlling its direction of output rotation) to power the motor(s) 100 to control its operation in a desired manner. The memory 148c may include a random access memory (“RAM”), read-only memory (“ROM”), flash memory, or the like for storing the set of instructions, and may be provided internal the processor 148c or externally provided as a memory chip mounted to the PCB 145, or both. The memory 148c may also store an operating system for general management of the ECU 144,144a. As such, the electrical components 148 with the PCB(s) 145 can be considered an embodiment of the control circuitry provided by the ECU 144,144a which operate together to form at least one computing device for processing data by a processor (e.g. processor 148c) such as communication signals, command signals, sensor signals, feedback signals and executing code or instructions stored in a memory (e.g. memory 148c) and outputting motor 100 control signals and for processing other communication/control signals and algorithms and methods in a manner as illustratively described herein.

Referring to FIGS. 4 and 7, shown is one embodiment of the ECU 144 mounted on the first frame portion 14a, while the latch 43 and associated latch components 23 (e.g. ratchet 24) are mounted on the second frame portion 14b. The sensor(s) 148a can be such as a hall sensor mounted on the PCB 145 of the ECU 144 and thus able to sense positioning of a corresponding magnet 148a positioned on one or more of the latch components 23 (e.g. ratchet 24, etc.).

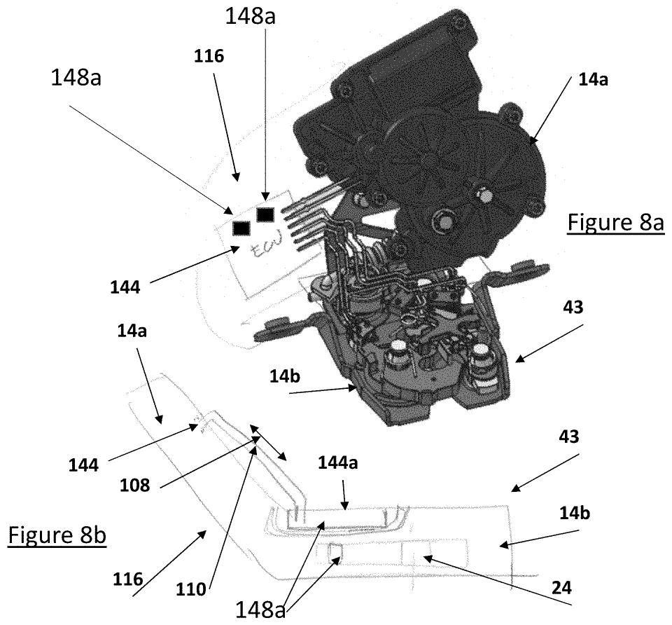

Referring to FIGS. 8a, 8b, shown are embodiments of the latch control module 116 having sensors 148a (e.g. radar Tx,Rx sensors 148a, LEDs 148a, etc.). In the embodiment of FIG. 8a, the auxiliary ECU 144a has sensor(s) 148a for interaction with the latch component(s) 23 (e.g. ratchet 24). For example, the ECU 144 can be equipped with a lighting and/or radar module for taking advantage of field of view of the liftgate 14 in the open position. Further, the auxiliary ECU 144a is coupled to the master ECU 144 positioned on the first frame portion 14a. Referring to FIG. 9, the ECU 144 can have a plurality of sensors 148ₐ mounted thereon, for example radar and/or position (e.g. hall) sensors. For example, FIG. 8b can show a cross section of slave/hall sensor ECU 144a adjacent to the ratchet 24, where for example the ECU 144a can be in its own housing 16a (see FIG. 4).

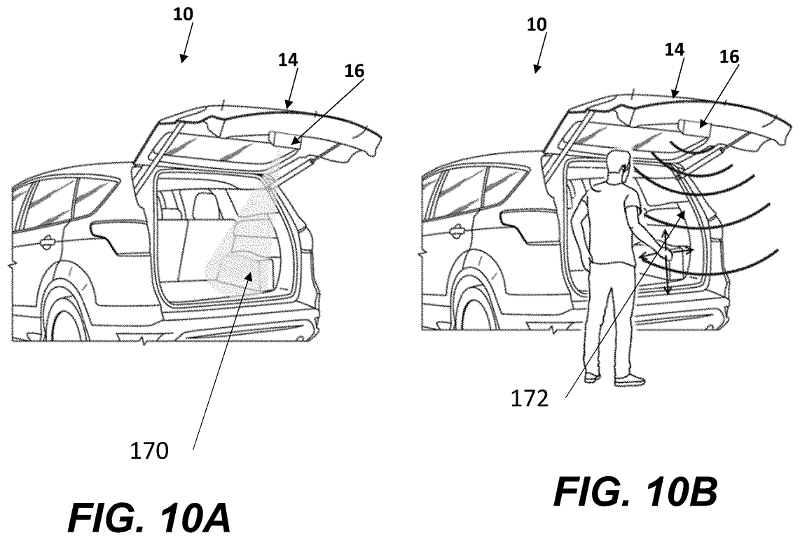

As shown in FIGS. 10a,10b, the ECU 144,144a in the housing 16 can be equipped with the lighting and/or radar sensor 148ₐ module(s) (see FIG. 6) for taking advantage of field of view of the lift gate 14 in the open position. As such, the closure panel 14 can be utilized as providing an excellent vantage point below the closure panel 14 when opened, and, since an ECU 144,144a is now provided in the latch housing 16 itself, the ECU 144,144a can be used to control LEDS 148ₐ and radar sensors 148ₐ pointed downwards below the closure panel 14 (e.g. lift gate). For example, shown in FIG. 10a is lighting 170 projected from the housing 16. For example, shown in FIG. 10b is a radar sensor field 172 projected from the housing 16 for gesture/obstable detection. Illustratively, FIG. 2A shows the radar sensors 148a as internal radar sensors 151a, or external radar sensors 151b electrically connected to the ECU 144. Illustartively FIG. 2A shows the illumination devices, such as LEDS as internal light device(s) 153a, or external light device(s) 153b electrically connected to the ECU 144. Further in communication with the ECU 144 may be provided a buzzer or audio device 157 activated by the ECU 144 for performing an alert function, for example during door opening, door closing, and a user interface device, such as a switch or button 159 for providing user input to the ECU 144 to initiate a door opening or door closing action, for example. Button 159 and buzzer 157 may rather be integrated into the latch 43.

As another illustrative example of locally controlled operation of the elatch 43, a manual override function is described. One or more Hall-effect sensors 148ₐ may be provided and positioned within the latch housing 16, as illustrated in FIG. 9 the Hall-effect sensors 148ₐ are positioned on the PCB 145 of the ECU 144 adjacent to the motor shaft 74, to send a signal, such as an analog voltage time varying signal depending of the change in magnetic field detected by the Hall-effect sensors 148ₐ, representative of operation (e.g. motor output shaft 74 rotation(s)) of the electric motor 100 to ECU 144 that are indicative of rotational movement of motor 100 and indicative of the rotational speed of motor 100, e.g., based on counting signals from the Hall-effect sensor 148ₐ detecting a target (i.e. magnet) on the motor output shaft 100. In situations where the sensed motor 100 speed is greater than a prestored expected threshold speed, stored in memory 148_{c} for example, and where a current sensor 148ₐ (in the case where ripple counting is employed to determine the operation of the motor 100, such as to determine the position of the motor 100) registers a significant change in a current draw, the ECU 144 can determine that a user is manually moving the closure panel 14 while motor 100 is also operating to operate the latch 43, thus moving the closure panel 14 between its opened and closed positions. The ECU 144 may then send in response to such a determination the appropriate actuation signals (by cutting the power flow to the motor 100 for example) resulting in the motor 100 to stop to allow a manual override/control of the closure panel 14 by a user. Conversely, and as an example of an object or obstacle detection functionality, when the ECU 144 is in a power open or power close mode and the Hall-effect sensors 148ₐ indicate that a speed of the motor 100 is less than a threshold speed (e.g., zero) and a current spike is detected (in the case where ripple counting is employed to determine the operation of the motor 100), the ECU 144 may determine that an obstacle or object is in the way of the closure panel 14, in which case the ECU 144 may take any suitable action, such as sending an actuation signal to turn off the motor 100, or sending an actuation signal to reverse the motor 100. As such, the controller ECU 144 receives feedback from the Hall-effect sensors 148ₐ, or from a current sensor (not shown) and renders control decisions locally to latch components 23 to ensure that a contact or impact with the obstacle and the closure panel 14 has not occurred during movement of the closure panel 14, or vice versa. An anti-pinch functionality may also be performed in a similar manner to the obstacle detection functionality, to particularly detect an obstacle such as a limb or finger is present between the closure panel 14 and the vehicle body 11 about the nearly fully closed position during the closure panel 14 transition towards the fully closed position. For example, as shown in FIG. 2A, anti-pinch or obstacle detections strips 155 may be provided in communication with the ECU 144. It is also recognized that in view of the above, similarly, the ECU 144 and associated sensors 148ₐ can be used to control the motor(s) 100 of the electronic control assembly 15 of the biasing member(s) 37, in view of detected manual operation of the closure panel 14, pinch detection, and/or obstacle detection, as desired. Biasing member(s) 37 may also optionally include a controller 101 having a motor driver (including FETS and H-bridge for example), such as described in US Patent Application No. 2020040802 titled “Integrated controller with sensors for electromechanical biasing member”, the entire contents of which are incorporated herein by reference. In a possible configuration, biasing member(s) 37 may be provided without a controller 101 and rather the motor driver for the biasing member(s) 37 form part of the ECU or controller 144. In a possible configuration of the liftgate 144, no other source of control for the latch 43 or the biasing member(s) 37 are provided on the liftgate 43 other than the ECU 144 provided as part of or within the latch 43.

While the ECU 144 has been described as executing decisions and algorithms to operate the motor 100 for obstacle detection, automatic close and open, anti-pinch functionality for the elatch 43 and/or biasing member 37, the controller ECU 144 may also be programmed to perform other functions. For example, such functionality executed by the ECU 144 may include dynamic closure panel 14 speed and torque control adjustments (i.e. the ECU 144 can detect an unlevel vehicle surface 9 and operate the motor 100 to adjust the torque output of the motor 100 required to move the closure panel 14), stop-and-hold position request (e.g. the ECU 144 can detect a user manually stopping the closure panel 14 and maintain the closure panel at this position), requests for motion (e.g. the ECU 144 can detect a user manually pushing the closure panel 14 and operate the motor 142 to move the closure panel 14 to the fully closed position, and the ECU 144 can detect a user manually pulling the closure panel 14 to move the closure panel 14 to the fully opened position), falling gate detection (e.g. the ECU 144 can detect a movement of the closure panel 14, due to for example a failed counterbalancing spring or biasing device and apply a brake mechanism (not shown) provided in the biasing member 37 to hinder the movement of the closure panel 14 towards the fully closed position), time based detected obstacle (e.g. the ECU 144 can track the length of time by implementing a counter function to determine the period of time over which the ECU 144 has determined that the speed of the motor 100 is less than a threshold speed (e.g., zero) and a current spike is detected (in the case where ripple counting is employed to determine the operation of the motor 100) indicative of an obstacle, zone detected obstacle (e.g. the ECU 144 can detect the presence of an obstacle in the path of movement of the closure panel 14 in the configuration where the ECU 144 is in communication with an proximity sensor 148ₐ, such as a radar sensor 148ₐ, is provided either externally to the biasing member 37 such as in latch 43, or internally in the biasing member 37. In the configuration where the radar sensor 148ₐ is provided internally the biasing member 37, the radar sensor 148ₐ may be provided on the PCB 145 and aligned with an aperture or port in the latch housing 16, if the latch housing 16 is manufacture from metallic material, to allow for radar signals to be transmitted and received therefrom. The ECU 144 in such a configuration may be configured to process the radar signal (i.e. FMCW or Doppler signals) and determine if obstacles are present), current detect obstacle (e.g. ECU 144 can determine a current spike is detected over the signal lines from the motor 100 to the ECU 144 in the case where ripple counting is employed to determine the operation of the motor 100. It is recognized that ripple counting techniques may do away with the Hall sensors 148ₐ and magnet and be replaced with processing by the ECU 144 involving calculating the ripple frequency using sensed the motor current measurements that has been bandpass filtered to process the relevant spectrum of the motor current), full open position request (e.g. the ECU 144 may automatically move the closure panel 14 to a fully opened positioned), learn completed request (e.g. the ECU 144 can detect the operating characteristics of the closure panel 14, such as the torque profile, and create an opening profile stored in the memory 144_{b} after operating the closure panel 14 in a training mode and sensing the movement represented by the feedback received by the sensors 148ₐ, after which the ECU 144 can optimize the torque output and speed for example of the motor 100 for moving the closure panel 14 after having learned the movement characteristics of the closure panel 14 during the training mode operation of the biasing member 37, for example immediately after the biasing member 37 having been installed on the motor vehicle 10, or after an aftermarket accessory has been added to the closure panel 14 resulting in an increase its weight and changing its moving characteristics), motor motion (e.g. the ECU 144 can operate the motor 100 at different torques and speeds depending on the position of the closure panel 14), adjustable stop position (e.g. the ECU 144 can operate the motor 100 to hold the closure panel 14 at a certain position based upon a received command signal which may include position and angle data), short to ground (e.g. the ECU 144 can diagnose operational faults in the control circuity or electric motor 100 and communicate to the external control system the fault, maintenance and troubleshooting codes and the like), short to battery (e.g. the ECU 144 can diagnose power supply line faults i.e. faults in Electrical power signal line or motor blade connections), open circuit for all components like (e.g. the ECU 144 can diagnose operational faults in the control components such as the motor 100, the Hall effects sensors 148ₐ, transient suppression faults, etc.). Other functions may include an unpowered rapid motor motion function which may also be performed by the ECU 144 (e.g. the ECU 144 may electrically disengage an electromechanical clutch of the biasing member 37). Other operating functions as determined and executed by the ECU 144 are also contemplated and are not limited to those described herein.

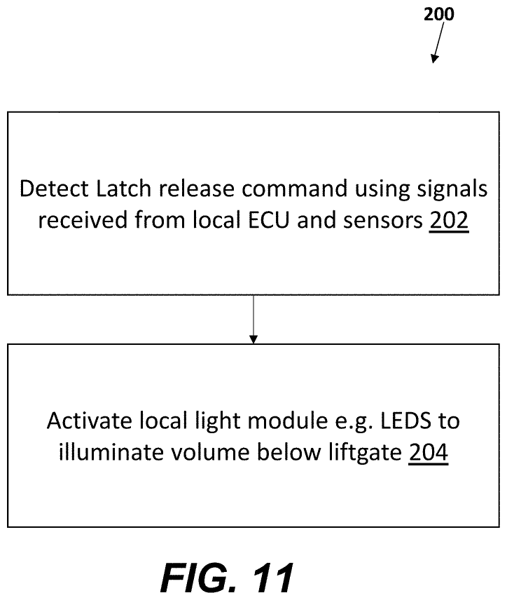

Referring to FIG. 11, shown is one example operation 200 of the latch control module 116. At step 202, the latch control module 116 detects a latch release command 108 using signals 108 received from the local ECU 144 and sensors 148ₐ. At step 204, the latch control module 116 activates local light module 148ₐ (e.g. LEDS) to illuminate volume below lift gate 14 (see FIG. 10a).

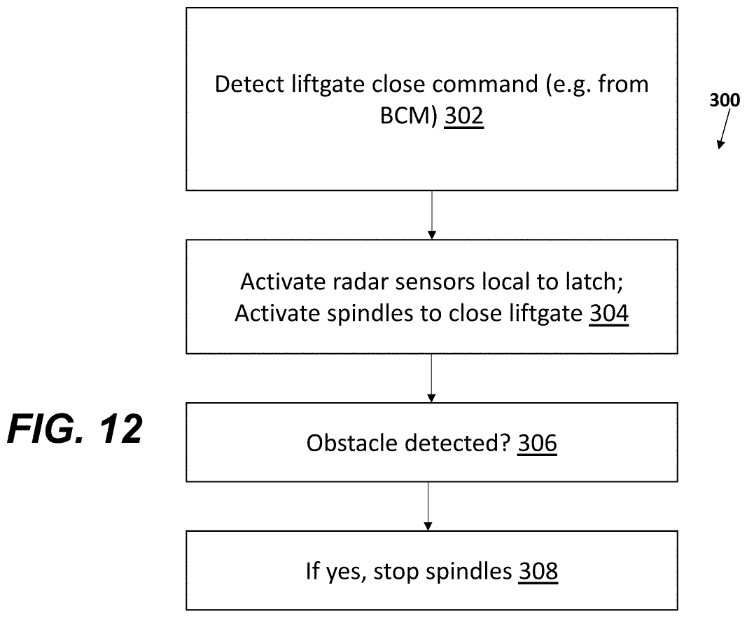

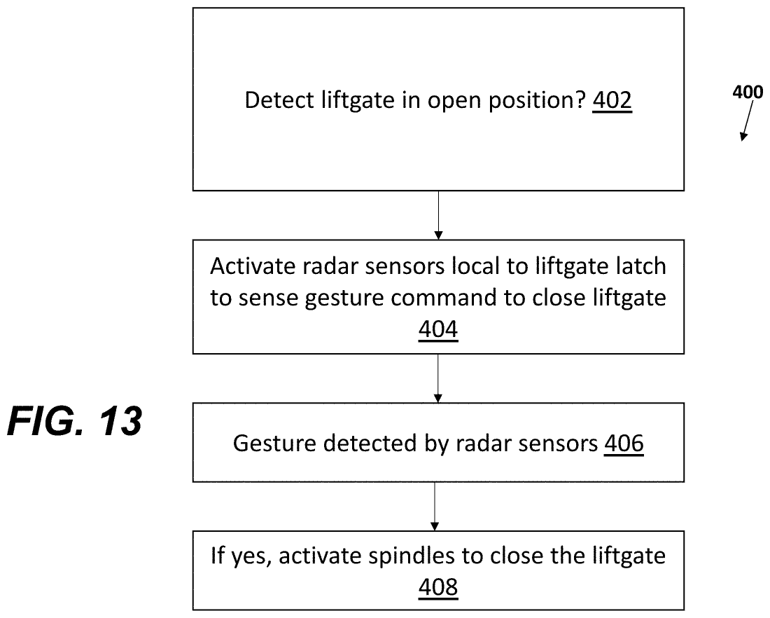

Referring to FIG. 12, a further example operation 300 with step 302 of detecting the liftgate, step 304 for activating the radar sensors 148a, step 306 to determine if obstacle detected by the ECU 144, and step 308 if detected then stop the operation of the closure panel 14 is provided. Referring to FIG. 13, a further example operation 400 with step 402 for detection of the liftgate 14 in the open position, step 404 for activating the radar sensors 148a, step 406 for detecting the gesture via the ECU 144, and step 408 for operating the liftgate 14 to close is provided.

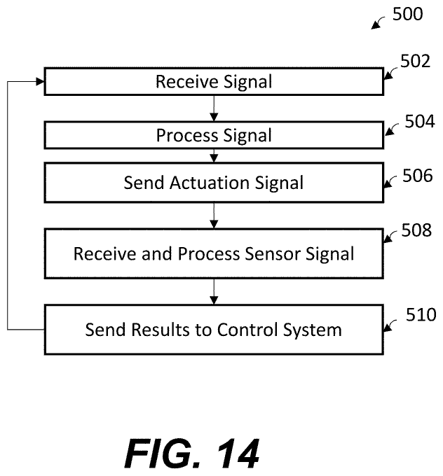

Referring to FIG. 14, a further example operation 500 with steps 502, 504, 506, 508, 510 is provided. In particular, the method 500 of providing the latch 43 mounted in the latch housing 16 includes positioning on the frame 16a of the latch housing 16: a set of latch components 23 of the latch 43; and an Electronic Control Unit (ECU) 144,144a having at least one sensor 148ₐ and a processor and memory 148_{c}; and coordinating operation of the set of latch components 23 by the ECU 144 in view of sensor signals 108 received (step 502) from the at least one sensor 148ₐ, process 504 the signal, send 506 the actuation signal to the latch 43 (e.g. the motor 100 of the latch 43), receive and process 508 feedback signals based on further sensor 148ₐ signals received by the ECU 144 in view of movement/operation of the latch 43 and/or the closure panel 14 (as indicated by operation of the electronic motor assembly 15) of the biasing member 37. Subsequently, the ECU 144 can send the results of the operation of the latch 43 and/or the closure panel 14 (e.g. via the operation of the electronic motor assembly 15 of the biasing member 37) to a further control module of the vehicle 10, e.g. a Body Control Module 6 (see FIG. 1).

In view of the above-described configuration, it is recognized that the ECU 144 can have its own software (e.g. set of operating instructions) stored in a physical memory 148_{c} for example to configure operation of the motor(s) 100 and optional receipt of the external signals (e.g. command signals) via the communication connections 110 to the controller ECU 144 (e.g. from the handles) and transmission of the signals (e.g. feedback signals) externally based on the detection by the internal electronic sensors (for example Hall-Effect sensors 148ₐ, ripple counting sensing) via a communication interface.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example detection system can likewise be implemented into many other systems to control one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

We claim:

1. A latch housing (16) for a latch (43) for mounting on a closure panel (14) of a vehicle (10), the latch housing comprising:
a frame (16a) having mounted thereon:
a set of latch components (23) of the latch; and
a latch control module (116) including an Electronic Control Unit (ECU) (144,144a) having at least one sensor (148ₐ) and a processor and memory (148_{c});
wherein the ECU coordinates operation of the set of latch components in view of a sensor signal (108) received from the at least one sensor.

2. The latch housing of claim 1 further comprising the frame as an angled frame having a first frame portion (14a) and a second frame portion (14b), such that the first frame portion and the second frame portion are angled relative to one another by an angle (A).

3. The latch housing of claim 2, wherein the first frame portion provides an actuation mechanism plane (17a) and the second frame portion provides a latch plane (17b), such that an actuation mechanism (43a) of the latch is mounted on the actuation mechanism plane and the set of latch components are mounted on the latch plane.

4. The latch housing of claim 2, wherein the ECU is mounted on the first frame portion.

5. The latch housing of claim 4 further comprising an auxiliary ECU mounted on the second frame portion, such that the auxiliary ECU is coupled to the ECU by a communications connection (110), the ECU acting as a main ECU to the auxiliary ECU.

6. The latch housing of claim 5, wherein the auxiliary ECU has a sensor of the at least one sensor.

7. The latch housing of claim 5, wherein the auxiliary ECU includes a PCB (145) having the at least one sensor mounted thereon.

8. The latch housing of claim 1, wherein the ECU includes a PCB (145) having the at least one sensor mounted thereon.

9. The latch housing of claim 1, wherein the at least one sensor is selected from the group consisting of: an integrated LED sensor; an induction sensor, a hall sensor, and a radar sensor; wherein the at least one sensor is for operation when the closure panel is in an open position.

10. The latch housing of claim 9, wherein at least one of the set of latch components comprises a target to the at least one sensor.

11. The latch housing of claim 10, wherein the target is a magnet.

12. The latch housing of claim 10, wherein the target is a portion of the latch component.

13. The latch housing of claim 1, wherein the closure panel is a lift gate and the latch is a liftgate latch.

14. The latch housing of claim 1, wherein the closure is not provided with another electronic control unit other than the electronic control unit.

15. The latch housing of claim 14, wherein the another electronic control unit is a Door Control Unit (DCU) or a Liftgate Control Unit (LCU) Module mounted remotely from the latch.

16. The latch housing of claim 1, wherein the closure panel is a lift gate and the at least one sensor is oriented downwards when the lift gate is in the open position.

17. The latch housing of claim 1, wherein the ECU also coordinates operation of an electronic motor assembly (15) of a biasing member (37) in response to receiving the sensor signal from the at least one sensor.

18. A method of providing a latch (43) mounted in a latch housing (16), the latch housing for mounting on a closure panel (14) of a vehicle (10), the method comprising:
positioning on a frame (16a) of the latch housing:
a set of latch components (23) of the latch; and
an Electronic Control Unit (ECU) (144,144a) having at least one sensor (148ₐ) and a processor and memory (148_{c}); and
coordinating operation of the set of latch components by the ECU in view of a sensor signal (108) received from the at least one sensor.

19. The method of claim 18 further comprising the ECU coordinating operation of an electronic motor assembly (15) of a biasing member (37) in response to receiving the sensor signal from the at least one sensor.

20. The method of claim 18 further comprising mounting the at least one sensor on the a first frame portion for sensing the set of latch components mounted on a second frame portion, such that the first frame portion and the second frame portion are provided at an angle to one another.
